(19) United States
(12) Patent Application Publication
(10) Pub. No.: US 2014/0001127 A1
(43) Pub. Date: Jan. 2, 2014

(54) PORTABLE STORMWATER TREATMENT SYSTEM AND METHOD

(71) Applicants: David Paul Hymel, Eatonville, WA (US); Marliyn Marie Jacobs, Gig Harbor, WA (US)

(72) Inventors: David Paul Hymel, Eatonville, WA (US); Marliyn Marie Jacobs, Gig Harbor, WA (US)

(21) Appl. No.: 13/832,492

(22) Filed: Mar. 15, 2013

Related U.S. Application Data
(60) Provisional application No. 61/666,766, filed on Jun. 29, 2012.

(51) Int. Cl. C02F 1/00

(52) U.S. Cl. CPC C02F 1/006
USPC 210/747.2; 210/170.03

(57) ABSTRACT

Systems and methods are involved with but are not limited to: a freestandable container including one or more wall portions extending at least in part from said perimeter of said one or more floor portions to bound an interior space; said one or more perforated piping portions extending through said interior space and coupled to one or more passageways through one or more of said wall portions; and a plurality of members coupled to said one or more floor portions and extending from said one or more floor portions to distance said one or more exterior surface portions of said one or more floor portions from a horizontally oriented surface when said plurality of members are in contact therewith. In addition to the foregoing, other method aspects are described in the claims, drawings, and text forming a part of the present disclosure.

### CLAIM OF PRIORITY

This application claims the benefit of priority under 35 U.S.C. §119(e) of U.S. Provisional Patent Application Ser. No. 61/666,766, entitled “BIORETENTION PLANTER,” filed on Jun. 29, 2012, which prior application is incorporated by reference herein in its entirety.

### SUMMARY

In one aspect, a system includes, but is not limited to a freestandable container including one or more floor portions with one or more interior surface portions, with one or more exterior surface portions, and with a perimeter, said freestandable container including one or more wall portions coupled to said one or more floor portions and extending at least in part from said perimeter of said one or more floor portions to bound an interior space by said one or more interior surface portions of said one or more floor portions and said one or more wall portions; one or more piping portions including one or more perforated piping portions having a plurality of perforations for receiving water, said one or more perforated piping portions extending through said interior space and coupled to one or more passageways through one or more of said wall portions; and a plurality of members coupled to said one or more floor portions and extending from said one or more floor portions to distance said one or more exterior surface portions of said one or more floor portions from a horizontally oriented surface when said plurality of members are in contact therewith. In addition to the foregoing, other system aspects are described in the claims, drawings, and text forming a part of the disclosure set forth herein.

In one aspect, a system includes, but is not limited to a freestandable container including one or more floor portions and including one or more wall portions extending therefrom to define an interior space thereby; one or more piping portions including one or more perforated piping portions having a plurality of perforations for receiving water, said one or more perforated piping portions extending through said interior space and coupled to one or more passageways through one or more of said wall portions; and one or more points of attachment coupled to said freestandable container for coupling of one or more hook portions and including structural reinforcement of said one or more points of attachment and including structural reinforcement of said freestandable container to provide load bearing capacity to accommodate lifting of said freestandable container through said one or more hook portions coupled to said one or more points of attachment. In addition to the foregoing, other system aspects are described in the claims, drawings, and text forming a part of the disclosure set forth herein.

In one aspect, a system includes, but is not limited to a freestandable container including one or more floor portions and including one or more wall portions coupled to said one or more floor portions and extending therefrom to bound an interior space by said one or more floor portions and said one or more wall portions, said freestandable container including structural strengthening to provide rigidity for at least partial lifting of said freestandable container; one or more piping portions coupled therewith, said one or more piping portions at least including one or more perforated piping portions having a plurality of perforations for receiving water, said one or more perforated piping portions extending through said interior space and coupled to one or more passageways through one or more of said wall portions; and a valve assembly coupled to said one or more piping portions, the valve assembly having at least two cross-sectional area settings for adjustment of flow rate of fluid through said valve assembly. In addition to the foregoing, other system aspects are described in the claims, drawings, and text forming a part of the disclosure set forth herein.

In one aspect, a system includes, but is not limited to a first freestandable container including one or more floor portions and including one or more wall portions coupled to said one or more floor portions and extending therefrom to bound an interior space by said one or more floor portions and said one or more wall portions, said first freestandable container including structural reinforcement to provide rigidity for at least partial lifting of a portion of said first freestandable container from prior ground contact; a first piping system including one or more perforated piping portions coupled therewith, the one or more perforated piping portions having a plurality of perforations for receiving water, said one or more perforated piping portions extending through said interior space of said first freestandable container and coupled to one or more passageways through one or more of said wall portions of said first freestandable container; a second freestandable container for placement including at least aboveground placement, said second freestandable container including one or more floor portions and including one or more wall portions coupled to said one or more floor portions and extending therefrom to bound an interior space by said one or more floor portions and said one or more wall portions, said second freestandable container including structural reinforcement to provide rigidity for at least partial lifting of a portion of said second freestandable container from prior ground contact; and a second piping system including one or more perforated piping portions coupled therewith, the one or more perforated piping portions having a plurality of perforations for receiving water, said one or more perforated piping portions extending through said interior space of said second freestandable container and coupled to one or more passageways through one or more of said wall portions of said second freestandable container, said first piping system of said first freestandable container being coupled to said second piping system of said second freestandable container. In addition to the foregoing, other system aspects are described in the claims, drawings, and text forming a part of the disclosure set forth herein.

In one aspect, a method includes, but is not limited to providing a first freestandable container including one or more floor portions and including one or more wall portions coupled to said one or more floor portions and extending therefrom to bound an interior space by said one or more floor portions and said one or more wall portions, said first freestandable container including structural reinforcement to provide rigidity for at least partial lifting of a portion of said first freestandable container from prior ground contact; providing a first piping system including one or more perforated piping portions coupled therewith, the one or more perforated piping portions having a plurality of perforations for receiving water, said one or more perforated piping portions extending through said interior space of said first freestandable container and coupled to one or more passageways through one or more of said wall portions of said first freestandable container; providing a second freestandable container for placement including at least aboveground placement, said second freestandable container including one or more floor portions and including one or more wall portions coupled to said one or more floor portions and extending therefrom to bound an interior space by said one or more floor portions and said one or more wall portions, said second freestandable container including structural reinforcement to provide rigidity for at least partial lifting of a portion of said second freestandable container from prior ground contact; providing a second piping system including one or more perforated piping portions coupled therewith, the one or more perforated piping portions having a plurality of perforations for receiving water, said one or more perforated piping portions extending through said interior space of said second freestandable container and coupled to one or more passageways through one or more of said wall portions of said second freestandable container; and coupling said first piping system of the first freestandable container to said second piping system of said second freestandable container. In addition to the foregoing, other method aspects are described in the claims, drawings, and text forming a part of the disclosure set forth herein.

In addition to the foregoing, various other aspects are set forth and described in the teachings such as text (e.g., claims and/or detailed description) and/or drawings of the present disclosure. The foregoing is a summary and thus may contain simplifications, generalizations, inclusions, and/or omissions of detail; consequently, those skilled in the art will appreciate that the summary is illustrative only and is NOT intended to be in any way limiting. Other aspects, features, and advantages of the devices and/or processes and/or other subject matter described herein will become apparent in the teachings set forth herein.

### BRIEF DESCRIPTION OF THE FIGURES

For a more complete understanding of embodiments, reference now is made to the following descriptions taken in connection with the accompanying drawings. The use of the same symbols in different drawings typically indicates similar or identical items, unless context dictates otherwise.

With reference now to the figures, shown are one or more examples of portable stormwater treatment systems and/or methods that may provide context, for instance, in introducing one or more processes and/or devices described herein.

FIG. 1 is a perspective view of an exemplary implementation of a portable stormwater treatment system without treatment media.

FIG. 2 is another perspective view of the exemplary implementation of a portable stormwater treatment system of FIG. 1.

FIG. 3 is a top plan view of the exemplary implementation of a portable stormwater treatment system of FIG. 1.

FIG. 4 is a side-elevational cross-sectional longitudinal view of the exemplary implementation of a portable stormwater treatment system of FIG. 1.

FIG. 5 is a side-elevational cross-sectional first end view of the exemplary implementation of a portable stormwater treatment system of FIG. 1.

FIG. 6 is a side-elevational cross-sectional second end view of the exemplary implementation of a portable stormwater treatment system of FIG. 1.

FIG. 7 is a top plan view of the exemplary implementation of a portable stormwater treatment system of FIG. 1 showing further external piping detail.

FIG. 8 is a side-elevational cross-sectional longitudinal view of the exemplary implementation of a portable stormwater treatment system of FIG. 1 with treatment media.

FIG. 9 is a side-elevational longitudinal view of an exemplary implementation of a portable stormwater treatment system of FIG. 8 showing two portable stormwater treatment systems coupled together to form a network of portable stormwater treatment systems in which stormwater is introduced serially.

FIG. 10 is a side-elevational cross-sectional longitudinal view of the exemplary network of portable stormwater treatement systems of FIG. 9.

FIG. 11 is a side-elevational cross-sectional longitudinal view of the exemplary network of portable stormwater treatement systems of FIG. 9 in which stormwater is introduced in parallel.

FIG. 12 is a schematic diagram of an exemplary implementation of a valve assembly that can be used with portable stormwater treatment implementations.

FIG. 13 is a side-elevational longitudinal view of an exemplary implementation showing multiple portable stormwater treatment systems coupled together to form a network of portable stormwater treatment systems in which stormwater is being introduced at a mid-point system of the network.

FIG. 14 is a side-elevational longitudinal view of an exemplary implementation showing multiple portable stormwater treatment systems coupled together to form a network of portable stormwater treatment systems in which stormwater is introduced at an end-point system of the network.

FIG. 15 is a top plan view of an exemplary implementation showing multiple portable stormwater treatment systems coupled together in parallel along with others coupled in series to form a network of portable stormwater treatment systems.

FIG. 16 is a side elevational view showing two portable stormwater treatment systems having different elevations and forming a network of portable stormwater treatment systems.

FIG. 17 is a side elevational view showing multiple portable stormwater treatment systems vertically stacked to form a network of portable stormwater treatment systems.

FIG. 17A is a side elevational view showing multiple portable stormwater treatment systems vertically stacked in a staggered fashion thereby allowing for plant growth therein and thereby forming a network of portable stormwater treatment systems.

FIG. 18 is a side elevational view showing a portable stormwater treatment system integrated with a conventional inground stormwater treatment system having different elevations.

FIG. 19 is a schematic view of a remotely controlled portable stormwater treatment system.

FIG. 20 is a side elevational view of a forklift lifting an exemplary implementation of a portable stormwater treatment system.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

The present application may use formal outline headings for clarity of presentation. However, it is to be understood that the outline headings are for presentation purposes, and that different types of subject matter may be discussed throughout the application (e.g., device(s)/structure(s) may be described under process(es)/operations heading(s) and/or process(es)/operations may be discussed under structure(s)/process(es) headings; and/or descriptions of single topics may span two or more topic headings). Hence, the use of the formal outline headings is not intended to be in any way limiting.

Combined sewer overflow (CSO) can occur when stormwater overloads a sewage treatment plant thereby causing sewage to be dumped in bodies of water having been less than adequately treated. Government agencies such as the U.S. Environmental Protection Agency have identified goals for reduction of CSO. As described herein, implementations of portable stormwater treatment systems can be used to add filtration and flow control capacity so that CSO can be reduced. Portability allows for systems to be more readily tailored and also reconfigured as conditions and requirements change.

Bioretention methods can remove stormwater pollutants, and reduce stormwater runoff quantity and surface runoff flow rates. When adjacent native soils have adequate infiltration rates, bioretention can be used for flow control and treatment requirements. Where the native soils have low infiltration rates, under-drain systems can be used to filter pollutants and detain flows that exceed infiltration capacity of the surrounding soil. Bioretention methods can use designed soil mixes and plants adapted to the local climate and soil moisture conditions, which receive stormwater from a contributing area. Various bioretention designs using soil and plant complexes to manage stormwater. For instance, conventional bioretention planters and planter boxes can have designed soil mix and a variety of plant material including trees, shrubs, grasses, and/or other herbaceous plants within a vertical walled container usually constructed from formed concrete, but could include other materials. Planter boxes are completely impervious and include a bottom and an under-drain.

Unlike conventional approaches, in implementations, exemplary portable stormwater treatment systems can utilize fabricated 14 CY roll off steel containers as elevated, portable, scalable bio-retention planter box systems that receive rain water input from downspout systems, pumped from catch basin systems, or other stormwater collection systems. These and other implementations of portable stormwater treatment systems detain, control flow, and filter rain water through a media mixture including soil, compost, root systems of drought tolerant plants, and gravel. Treated water exits through an outflow point with orifice sizing chosen regarding capacity requirements of a stormwater collection area such as a roof, parking lot, street, other impermeable surface such as at construction sites, parks, game preserves, and other natural habitats, etc. With increased capacity provided by one or more of the portable stormwater treatment systems in place, stormwater can be more safely detained and handled without overflowing into storm conveyance systems, thereby providing enhanced flow control and filtration capability.

Flow control and filtration computer modeling can establish capacity of single or multiple portable stormwater systems that can stand alone or be connected in one or more networks depending upon capacity requirements to treat stormwater from one or more contributing areas. Implementations can also include an Internet capable or other remotely controlled switching and control assembly to vary output orifice size of one or more valves and change, in real time or near-real time, the capacity of one or more portable stormwater treatment systems to adapt to changing storm events. Through modeling and other planning tools the portable stormwater treatment systems can also be tailored through placement, capacity sizing, network configuration and/or etc., to achieve at or near maxium amount of flow throughput capacity while maintaining desired levels of filtration. Remotely controlled management of standalone and/or networked portable stormwater treatment systems can in some situations reduce the number of systems needed for a particular site and can also increase effectiveness of controlling stormwater flow.

The portable stormwater treatment systems also include overflow plumbing to handle events where capacity of a system has been reached. The overflow plumbing is physically isolated from plumbing used to handle treated water so that an overflow event can be adequately addressed without interfering with available treatment capacity.

In implementations an assembly of three, ¾ inch standard irrigation flow control valves can be mounted on a ¾ inch PVC pipe manifold to allow for adjustability of flow control. Each of these valves can be connected to different zones on an irrigation controller and can be physically separated from the container of the portable stormwater treatment system if desired. The controller can be managed on site or can be remotely managed via the Internet through computers, smart phone devices, tablets, etc. In implementations, two additional valves and reducers to ¼ and ½ inch respectively can be used to manage outflow. Individual outflows from each of ¼ and ½ inch orifices can be each reconnected back into a single ¾ in pipe coming out of the assembly to be connected into an overflow pipe mounted at the back and exterior of the portable stormwater treatment system. All flows can then be directed into an appropriate conveyance system associated with the related site.

Implementations utilize lightweight design and steel construction to provide deployment opportunities for green stormwater facilities. Further implementations are designed to be rapidly and inexpensively transported and deployed on a variety of general and special purpose vehicles, from the roll-off container truck, to tilting flatbed trailers, to standard truck and trailer combinations. Implementations include those with four steel roller wheels and several attachment points for lifting for movement by lifting either through cables, chains, belts, ropes, forklift forks, etc., and/or pushed, and/or rolled into final position with delivery vehicle, forklift or other load handling equipment. Implementations are configured to be light enough, such as being two tons total weight when empty without containing media material so that three or four people of sufficient strength capability can push the portable stormwater treatment system a short distance on a hard level surface.

Installation methods include preparing portable stormwater treatment systems for service and separately configuring the stormwater connections at the service location. After the associated container has been fabricated and painted, the internal underdrain, and outflow and overflow piping and gravel layer can be installed before delivery to the service location. The soil medium and finish mulch can also be installed depending on the capacity of the delivery vehicle and load handling equipment at the site. This process can be completed in some situations in less than one hour. Similarly, the service location stormwater connections can also be preconfigured in advance. For example, a roof downspout may only require cutting a section of pipe roughly the height of one or more of the portable stormwater treatment systems; installing one or more quick disconnect coupler fittings and temporarily reinstalling the cut section. Once the one or more portable stormwater treatment systems have been delivered and rolled or otherwise placed into position, the temporary section is removed and the upper downspout is connected into a preconfigured dispersal pipe that rests loosely on the surface of mulch contained in the one or more portable stormwater treatment systems. Outlet and overflow pipes from the one or more portable stormwater treatment systems are then connected into one or more lower downspout pipe fittings thereby completing the stormwater connection. In the exemplary implementations, plants are then added into the portable stormwater treatment system and watered in to complete the bioretention planter box system. This entire process after delivery can take about two hours for some implementations.

Implementations of portable stormwater treatment systems are configured as portable, scalable, and elevated above ground so that the undercarriage with its external floor surface portions having enhanced accessibility compared with if most or all of the system was in direct ground contact. Enhanced accessibility through above ground elevation allow for unique opportunities in site deployment design, and in its operations and maintenance methods.

For instance, implementations of the portable stormwater treatment system can be deployed to detain, control flow, and/or filter stormwater in locations near sensitive water bodies and in areas where the permanent cover must not be disturbed because of contaminated soils underneath. The above ground and elevated reduced ground contact nature of implementations of the portable stormwater treatment system can be advantageous, for instance, in that certain shoreline permits normally required for below ground planter boxes or similar vault installations will not be required for deployment. This reduction of regulation processing and other paperwork can factor into time and cost savings for project owners. Also, costs of vault excavation and installation are avoided with a rapidly deployed surface installation. With the elevated above ground approaches, implementations of the portable stormwater treatment systems can also be readily modified, reconfigured, deployed, and/or integrated into a wide range of projects such as parklet green up projects, providing essential stormwater services while doubling as an urban street side or alley way amenity, such as providing outdoor bench-type furniture and parklet installations.

Implementations allow for facility operations change over time and allow for a mobile and scalable stormwater treatment system that is flexible and adaptive. For instance, if planning requirements change from an initial site design or if operations have expanded over time at a facility portable stormwater treatment system can be plumbed or otherwise coupled together to operate in series and/or parallel fashion allowing for introducing into a network of additional portable stormwater treatment systems such as in a treatment train series arranged configuration. Conversely, when onsite facility treatment requirements are reduced or otherwise eliminated, one or more of the portable stormwater treatment systems either standalone or of a network can be removed or reconfigured due to their relatively ready transportability to be relocated to a new service area.

Due in part to its elevated above ground nature, implementations can reduce complexity with visual inspection and repair compared, for instance, with below ground structures. For example, leaks are readily accessible to visually spot and to repair. Also, outflow and overflow portals are easily accessed for water sampling and clean out, and plants are easily observed and accessible for replacement and pruning. In implementations, use of proven steel box construction standards can ensure long service life; however replacements are easily rolled into place if offsite service is needed.

Implementations can be used as a bioretention planter box and can be used in jurisdictions that have combined sewer systems where flow rates and volumes need to be reduced so that stormwater combined with sewage doesn't spill into marine waters. Implementations can have filtration capacity that is also very high, such as 93% or more for all contributing areas having been modeled including 10,000 square feet. As reference, filtration target for bio retention systems can be 91%.

Various implementation sites can include filtration and flow control for downspout, roof, and pumping from oil-water separators, and/or catch basins that service such as asphalted truck shipping and receiving areas, and other treatment points at commercial, residential, industrial facilities, etc. Implementations of particular sized portable stormwater treatment systems can include treatment of between 1,000 and 3,000 sq. ft. roof or pavement area.

Hydrologic modeling has been used to assess the performance of single and double portable stormwater treatment system configurations with orifice control relative to regional combined sewer overflow (CSO) control goals. For instance, performance of a single and dual portable stormwater treatment systems connected in series has been evaluated using continuous simulation hydrologic modeling to assess peak flow reduction for the 1-, 2-, and 25-year recurrence interval flows. The modeling methods are consistent with the requirements set forth by the 2009 City of Seattle Stormwater Flow Control & Water Quality Treatment Technical Requirements Manual. MGSFlood computer software was used with the 158-year Seattle precipitation series and the model was run at a 5-minute time step. The portable stormwater treatment system was represented based on the following of treatment container area of 16 feet length by 5.5 feet width (no bench included), surface ponding depth of 12 inches (overflow pipe set 12 inches above the top of the bioretention soil), six inches of freeboard (vertical distance between overflow pipe and top of system). A subsurface cross-section of live storage included 2 inches of mulch (modeled with same characteristics as bioretention soil), 18 inches of bioretention soil (porosity=40%; infiltration rate=3 inches per hour), 10 inches of aggregate (porosity=30%). Underdrain flows from an individual portable stormwater treatment system or two portable stormwater treatment systems in series were assumed to be controlled by a single 0.5 inch diameter orifice. The orifice invert elevation was set at the invert elevation of the underdrain pipe (2 inches above the bottom of the portable stormwater treatment system).

The table below summarizes the results of modeling.

Splash Boxx Flow Control Performance

| | Drainage | | | | Percent |
|---|---|---|---|---|---|
| | Area | 1-year | 2-year | 25-year | Runoff |
| Number | (square | Reduction | Reduction | Reduction | Treated |
| of Systems^{a} | feet)^{b} | (%)^{c,d} | (%)^{c,e} | (%)^{c,e} | (%)^{f} |
| 1 | 1,000 | 45% | 45% | 70% | 100% |
| 1 | 2,000 | 64% | 68% | 73% | 100% |
| 1 | 3,000 | 76% | 79% | 41% | 99.6% |
| 1 | 4,000 | 60% | 45% | 28% | 98.4% |
| 1 | 5,000 | 34% | 25% | 16% | 96.5% |
| 2 | 1,000 | 51% | 52% | 66% | 100% |
| 2 | 2,000 | 62% | 62% | 75% | 100% |
| 2 | 3,000 | 66% | 68% | 81% | 100% |
| 2 | 4,000 | 69% | 72% | 55% | 100% |
| 2 | 5,000 | 74% | 76% | 45% | 99.8% |
| 2 | 7,000 | 66% | 52% | 36% | 98.7% |
| 2 | 10,000 | 29% | 23% | 21% | 95.6% |

The following comments apply to the modeling. When more than one portable stormwater treatment system was modeled, the systems were modeled in series, assuming that the systems are connected at the underdrain elevation and the bioretention soil surface elevation (i.e., even in small events, both systems receive runoff). Underdrain flows from both systems were assumed to be controlled by a single 0.5 inch diameter orifice. The drainage area for the predeveloped scenario is assumed to be 100% impervious and does not include the system footprint. This assumption results in slightly conservative estimates of peak flow control performance. The “x-year Reduction” represents the reduction in x-year peak flow from a 100% impervious area. One-year recurrence interval flow calculated based on partial duration statistics (converted from MGSFlood annual duration statistics). Two-year and 25-year recurrence interval flows calculated based on annual duration statistics. “Percent Treated” represents the fraction of runoff that passes through the bioretention soil media and exits the facility via the orifice. Any water that leaves the system via the overflow structure does not receive treatment.

For CSO control, some regulative agencies use reduction in the 1-year in peak flow as a metric for evaluating stormwater facility performance. In addition, some agencies have green stormwater infrastructure (GSI) to the “maximum extent feasible” requirement focusses on reductions in the 1-year flow. Based on this preliminary effort, it appears that the maximum reduction in the 1-year flow realized by the exemplary implementation of a portable stormwater treatment system was modeled to be between 75 to 80%.

The performance of the single and double portable stormwater treatment system configurations were compared. For smaller contributing areas, the additional system exemplary implementation actually decreased the facility performance relative to the single system configuration. This can be because the second system can double the infiltrating surface area, resulting in less attenuation of flows via infiltration through the soil. However, with larger contributing areas, the second system provides the additional storage required to handle the larger runoff volume without generating overflows. While cost could come into play in decisions on how many systems to use on a particular site, the addition of more systems in series (3, 4, etc.) would likely follow a similar pattern. For instance, assuming the one-year flow is a target flow, once a dual-system network begins to overflow (some contributing area greater than 7,000 sf) a third Boxx could be added to realize better reductions in the one-year peak flow than the system configuration.

For some agency control standards, post-development 25-year recurrence interval flow may not exceed 0.4 cubic feet per second per acre and the 2-year recurrence interval flows may not exceed 0.15 cubic feet per second per acre. The graph below illustrates the Splash Boxx performance relative to this metric. A range of contributing areas for which a single exemplary system implementation would meet the Peak Flow Control Standard can be approximately 2,000-2,400 sf or 2,400-3,800 sf. Note that the addition of more exemplary systems in series (3, 4, etc.) would likely follow a similar pattern. For instance, assuming the Peak Flow Control standard is a target, once the two exemplary systems cannot meet the target 25-year flows (some contributing area around 4,000 sf) a third Boxx could be added and you would likely meet the Peak Flow Control Standard for a range of larger contributing areas.

While this modeling effort did not include sizing the exemplary system for treatment requirements, the fraction of runoff that is filtered through the bioretention soil media (“Percent Treated”) is provided in the table above. Note that the percent filtered is much greater than the 91 percent required for treatment. This means that if the exemplary system is sized to maximize the reduction in the 1-year flow, the treatment standard can be also achieved.

Modeling results of exemplary systems indicate utility for flow control in the GSI implementations, particularly for controlling the 1-year peak flow. Additional implementations can include flow control performance as replacements or supplements to that of cisterns and planters without underdrains. Other implementations can include larger treated areas such as 3,500 square feet routed to an individual system and 6,000 square feet routed to two systems in series. In larger treated areas can be included in other implementations. Other implementations can rely more on higher multiples of systems networked together such as obtaining performance through orifice-controlled triple and quadruple system configurations (e.g., 3 and 4 systems in series) for use with larger contributing areas. Other implementations may use other orifice sizing such as different orifice sizing (e.g., a smaller orifice would improve 1-year peak reduction for an individual system, a larger orifice might improve 2- and 25-year reduction).

Implementations of portable stormwater treatment systems can include in a portable elevated container the following. The container of the portable stormwater treatment system include an underdrain and overflow directed to a designated discharge point. Exemplary portable stormwater treatment systems can be placed close to buildings or property lines or otherwise used in confined areas. Containers of implementations of the portable stormwater treatment systems are impermeable to prevent infiltration into the surrounding soils. Aggregate reservoir material contained within an exemplary container of a portable stormwater treatment system can include clean crushed ⅝ to ¾ inch rock (type 22 aggregate) to furnish temporary storage reservoir capacity and to surrounds and protect the underdrain. This reservoir can have a minimum depth of 12 inches. The underdrain pipe of portable stormwater treatment systems conveys infiltrated water to an approved discharge point. In implementations it can be connected to a downstream GSI such as another bioretention cell as part of a connected system, or to an approved discharge point.

The underdrain pipe material in implementations is a perforated, thick-walled plastic pipe. For example, a pipe having a minimum four-inch diameter can be used and can be embedded in a minimum of six inches of aggregate reservoir material in the container of an exemplary portable stormwater treatment system. An overflow pipe as part of an exemplary system can convey excess flow to an approved discharge point. The minimum freeboard measured from the invert of the overflow pipe to cell overtopping elevation can be be two inches for drainage areas less than 1,000 square feet and 6 inches for drainage areas 1,000 square feet or greater. The container of exemplary systems can contain a bioretention soil mix with a minimum 18-inch depth. Exemplary soil can exclude use of pesticides and synthetic fertilizers use, and use of an annual addition of organic matter in the form of compost, leaf litter or arborist woodchip mulch. Plant selection used by exemplary systems can be important since, for instance, plant roots can aid in the physical, biological, and chemical bonding of soil particles. Plant selection options can generally disallow annuals with a mix of evergreens and perennials being recommended. Generally the plants tolerate drought, ponding fluctuations and saturated soil conditions. Native plant species, placed appropriately, can better tolerate climate and biological stresses and usually require no nutrient or pesticide application in properly designed soils. Plants can include succession plants and hardy ground covers. Natives can be used exclusively or in combination with hardy cultivars.

Exemplary vegetation coverage of selected plants can achieve 90% coverage within two years. Implementations can prohibit turf forming grasses requiring mowing. Provisions can be made for supplemental irrigation during the first two growing seasons following installation. Mulch material can also be used to reduce weed establishment, regulate soil temperatures and moisture, and add organic matter to soil. Compost mulch is an excellent slow-release source of plant nutrients, but does not suppress weed growth as well as higher-carbon mulches such as wood chips. Compost is less likely to float than wood chip mulch and is an excellent source of organic materials and nutrients in above ground planters. Arborist wood chips are superior to bark mulch in promoting plant growth, feeding beneficial soil organisms, reducing plant water stress, and maintaining surface soil porosity. A minimum of two inches and a maximum of three inches of compost mulch is used in implementations. Implementations of mulch do not include grass clippings, mineral aggregate, or pure bark. Implementations include planter one or more ponding areas to provide surface storage above the mulch for storm flows, particulate settling, and the first stages of pollutant treatment within the cell. Implementations of the planter ponding area can have a depth of 12 inches. The surface pool drawdown time can be a maximum of 24 hours. In implementations, the point at which overflow water is directed out of a facility is called the discharge point. In implementations, portable stormwater treatment systems can be used in conjunction with other methods to achieve the site's overall mitigation requirements.

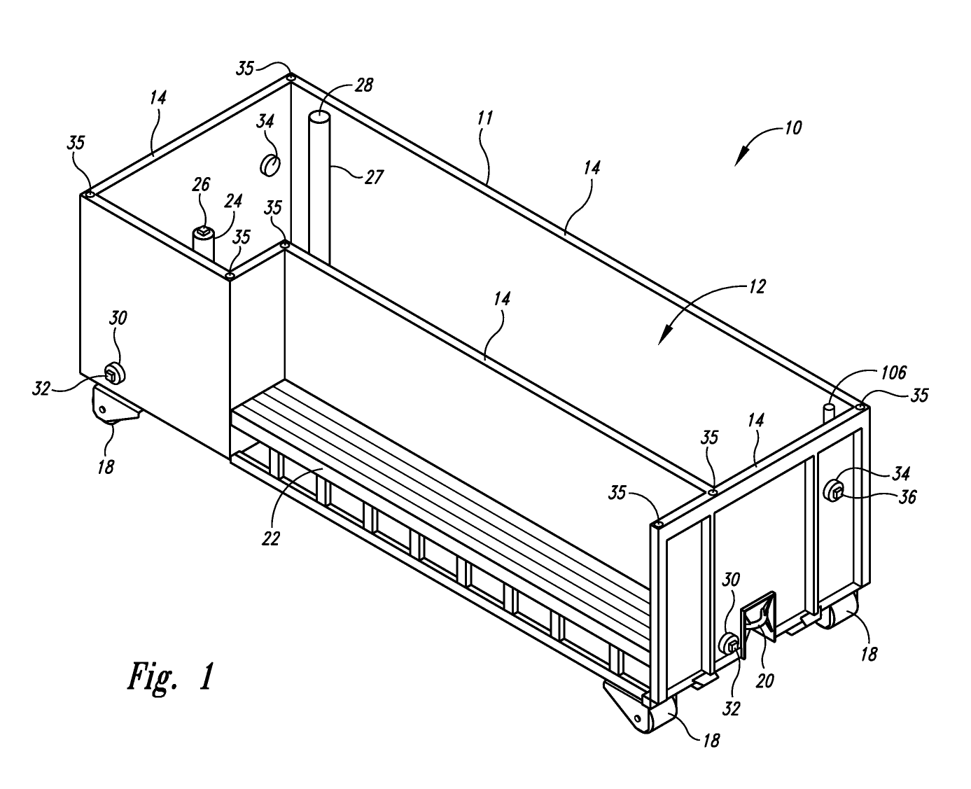

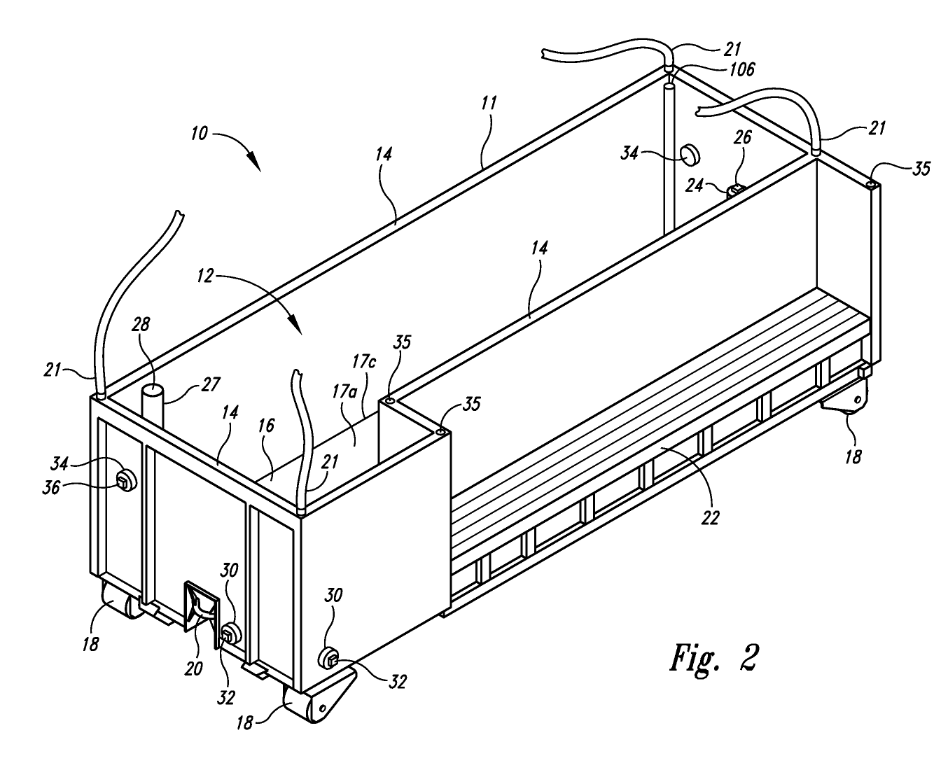

FIGS. 1 and 2 show perspective views of an exemplary implementation of a portable stormwater treatment system 10 having an interior space 12 bounded by wall portions 14 extending from a perimeter of floor portions 16. The floor portions 16 have interior surface portions 17a, exterior surface portions 17b, and a perimeter from which the wall portions 14 extend. A plurality of members 18 shown in FIGS. 1 and 2 as wheel portions extending from the exterior surface portions 17b of the floor portions 16 and resting on a horizontally oriented surface 19 (such as a parking lot, street, paved surface, or other surface) spaced a distance 19a from the exterior surface portions 17b of the floor portions 16. As shown, contact surface area of the plurality of members 18 with the horizontally oriented surface 19 can typically amount to 5% or less of the surface area of the exterior surface portions 17b of the floor portions 16 thereby allowing for much access to the floor portions for visual inspection, maintenance, lifting, etc. The plurality of members 18 can be coupled to the portable stormwater treatment system 10 through frictional forces, bolted portions, welded portions or other coupling mechanisms.

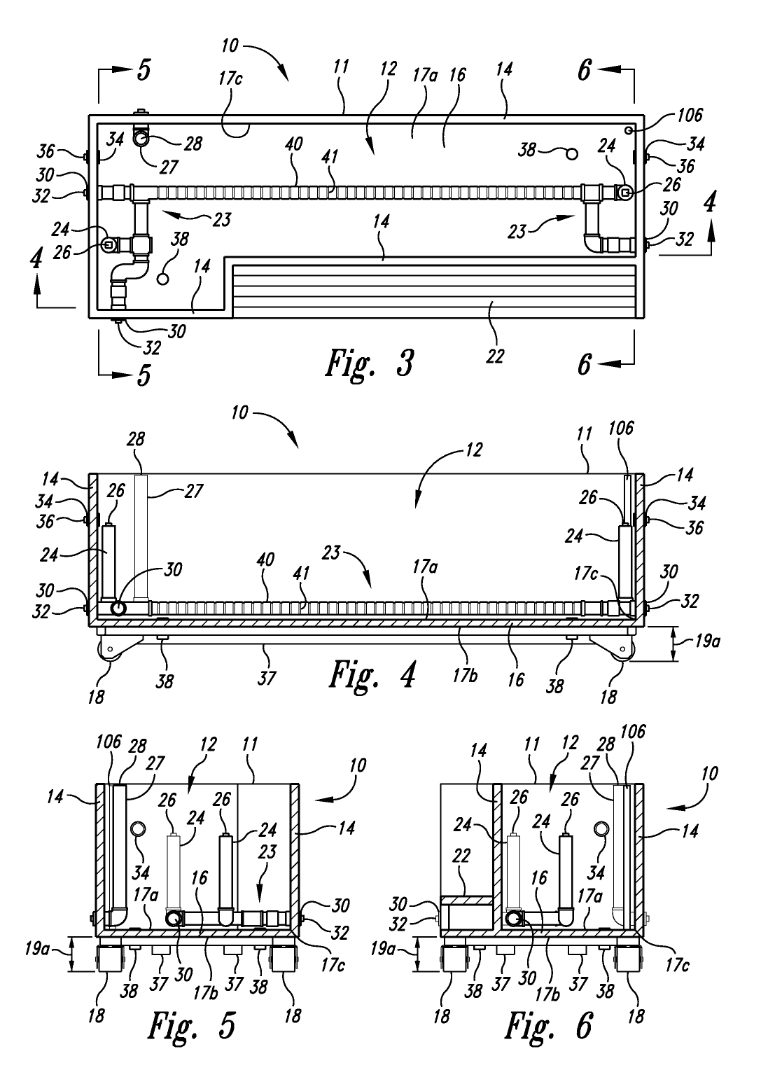

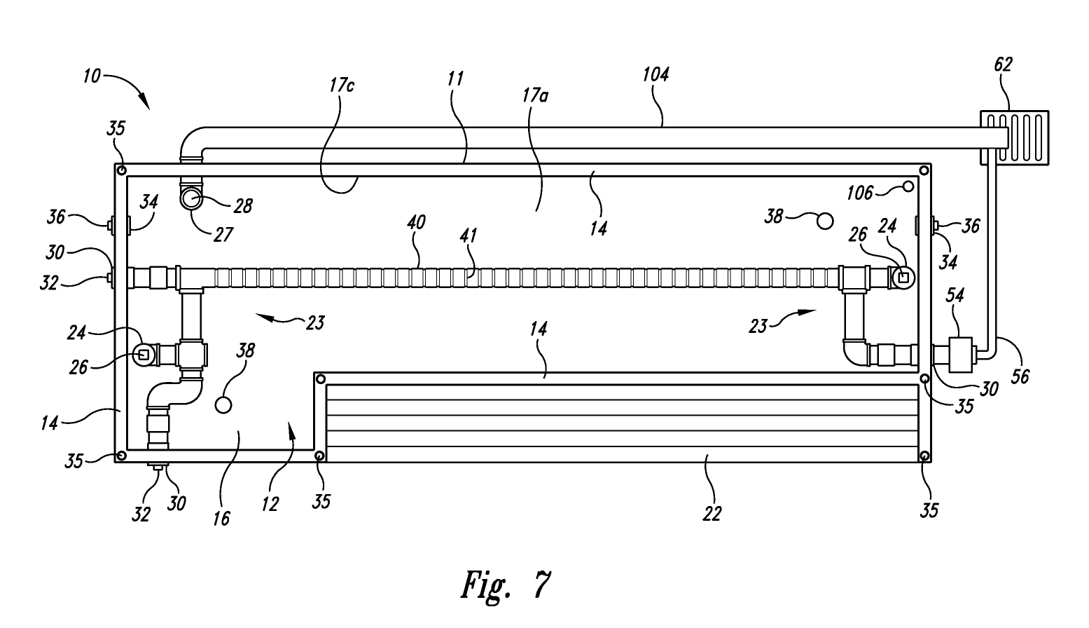

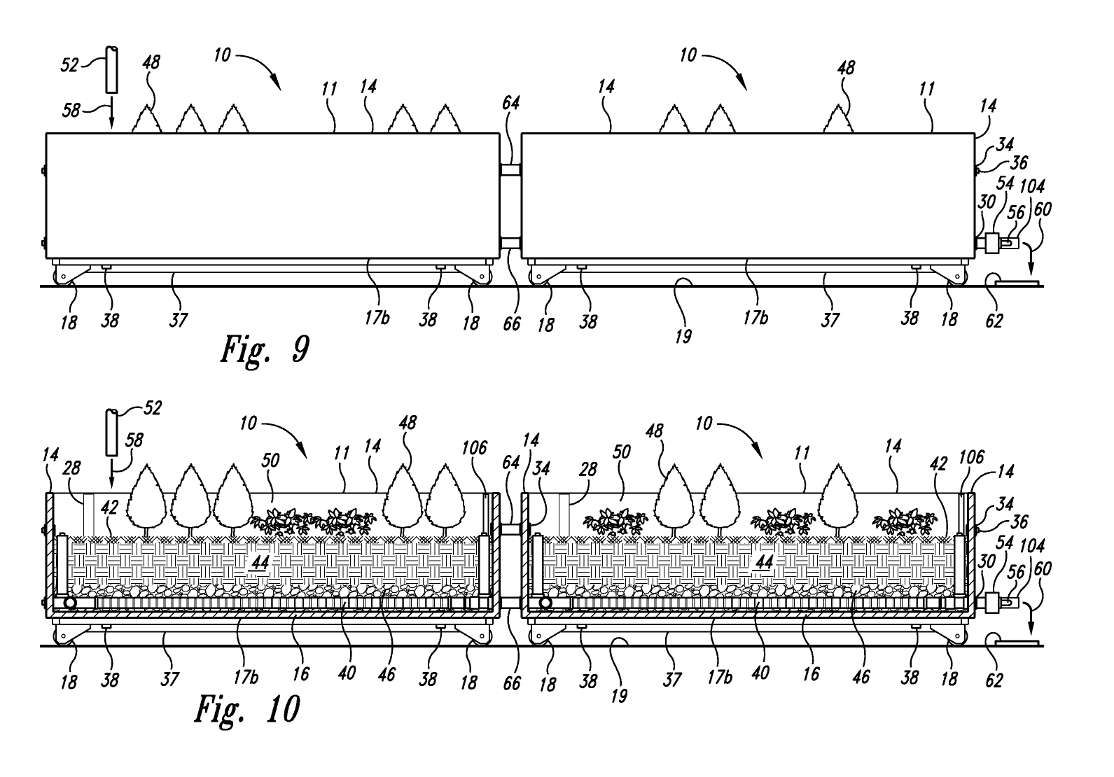

Points of attachment 20 are shown with hook portions 21 thereby attached for lifting of the portable stormwater treatment system 10. The portable stormwater treatment system 10 is shown with an integral bench 22 whereas other implementations have no bench. Piping portions 23 comprising a piping system extends within the interior space 12 and include cleanout 24 with cap 26, overflow piping 27 with top end 28 to receive water that cannot be otherwise processed by the portable stormwater treatment system 10. The piping system 23 further includes treated water outlet 30 (shown with optional cap 32) that serves as a passageway through one or more of the wall portions 14 for treated water received into perforated piping 40 shown with perforations 41 in FIGS. 3 and 4 through which treated water is received. Ponding water outlet 34 (shown with optional cap 36) is used to link ponding water of more than one of the portable stormwater treatment systems 10 together to form networks when treated outlet water outlets are also coupled together as shown for instance in FIG. 9. Drains 38 (shown capped) is found in the floor portions 16 are used to thoroughly drain the portable stormwater treatment system 10 prior to transport, maintenance, or other relevant operation. As shown in FIGS. 3 and 4, and better shown in FIGS. 5 and 6, support beams 37 run longitudinally along the exterior surface portions 17b of the floor portions 16 to allow for transport of the portable stormwater treatment system 10 when carrying a full load of treatment material enumerated below. FIG. 7 shows overflow piping 27 coupled to an exterior overflow piping 104 that carries untreated overflow water to a conveyance 62. Treated water exits the portable stormwater treatment system 10 through treated water outlet 30 shown in FIG. 7 coulped to a valve assembly 54 to adjustably control flow rate of the treated water. The treated water is carried to the conveyance by exterior treated water piping 56.

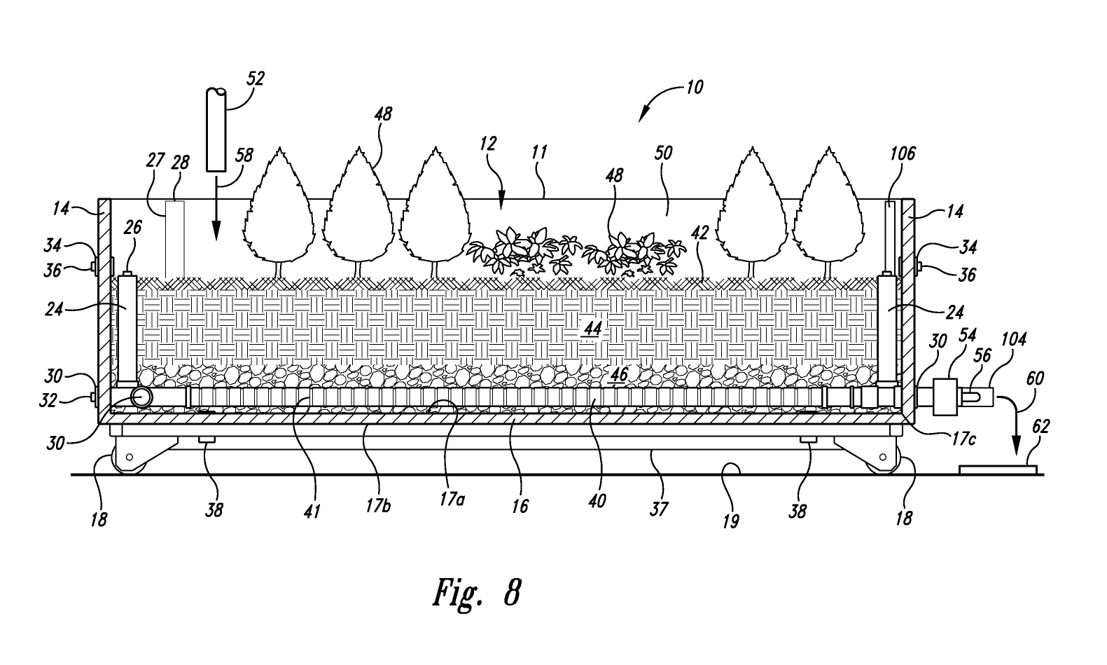

As shown in FIG. 8, the portable stormwater treatment system 10 can fully contain materials to treat stormwater such as a compost layer 42, a soil layer 44, a drainage material layer (such as crushed rock) 46 that can combine as a overall load. For example for an implementation of the portable stormwater treatment system of the floor portions 16 having a total for the interior surface portions 17a of the floor portions of approximately 60 square feet, a total load of treatment materials can weigh approximately 8 tons thus necessitating structural reinforcement of the floor portions to bear loads of at least 150 pounds per square foot and possibly more, such as 235 or 250 pounds per square foot, especially if it is envisioned that the portable stormwater treatment system 10 is to be moved with the treatment materials being contained therein. Another example has total load of treatment materials weighing approximately 10 tons for a total surface area of 88 square feet so that similar comments apply regarding structural reinforcement of the floor portions 16 such as found through use of support beams 37 or other such structural reinforcement. The wall portions 14 extending sufficiently vertically from the floor portions 16 to allow for a ponding layer 50 above the surface of the soil layer 44 to provide further detaining time for stormwater that may otherwise become overflow water received by the overflow piping 27.

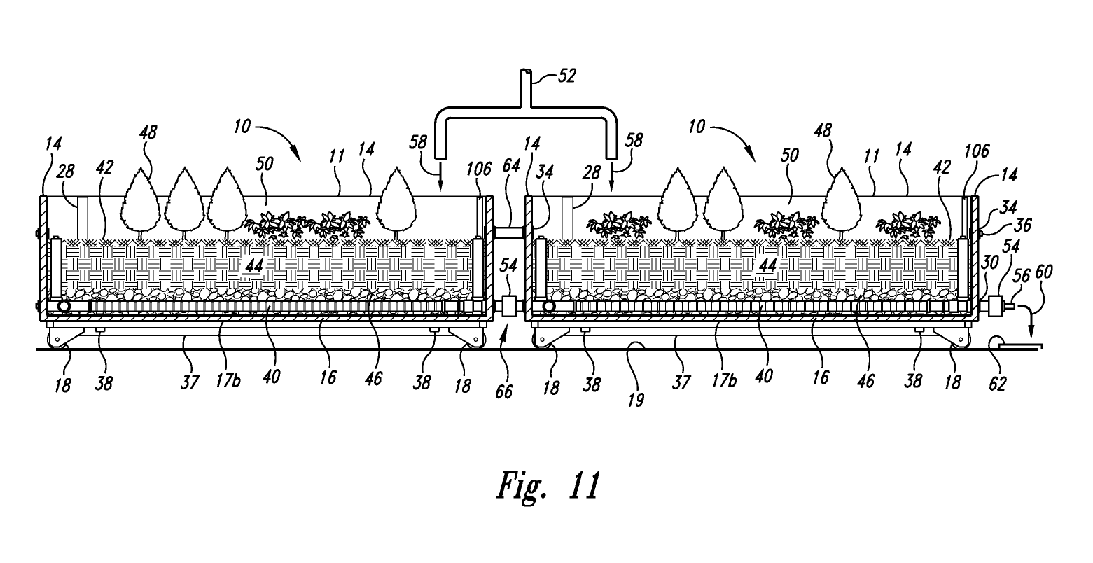

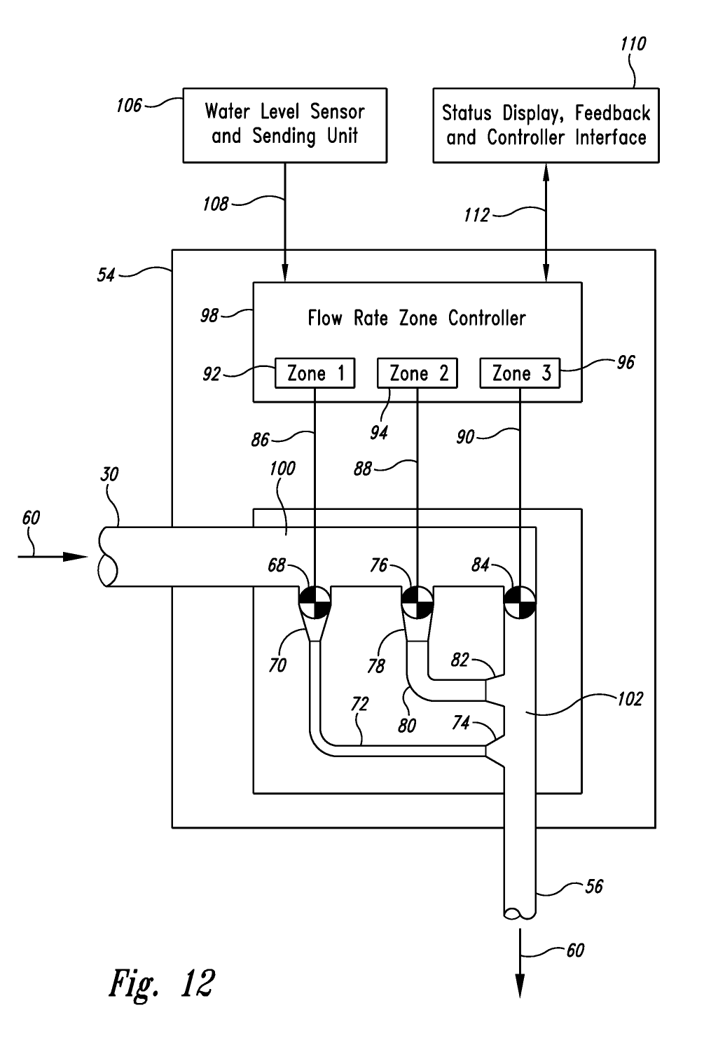

FIG. 8 shows inlet water from drain piping 52 such as a downspout being received by a standalone version of the portable stormwater treatment system 10 whereas FIGS. 9 and 10 show a series network of dual coupled portable stormwater treatment systems receiving drainage water 58 to be treated directly at a first system with a second system further receving some of the untreated ponded water from the first system through ponding water coupling 64 and receiving treated drainage water from the first system through underdrain coupling 66. FIG. 11 shows both dual coupled portable stormwater treatment systems directly receiving drainage water 58 to be treated.

FIG. 12 shows an implementation of the valve assembly 54 to include a manifold having first controlled valve 68, first orifice 70, first path 72, first expander 74, second controlled valve 76, second orifice 78, second path 80, second expander 82, third controlled valve 84. The first controlled valve 68 is shown being controlled via communication link 86 by first controller 92. The second controlled valve 76 is shown being controlled via communication link 88 by second controller 94. The third controlled valve 84 is shown being controlled via communication link 90 by third controller 96. Inlet pipe 100 supplies treated water from the treated water outlet 30 to the controlled valves and further on through outlet 102 to the exterior treated water piping 56 as treated discharge 60 into the conveyance 62.

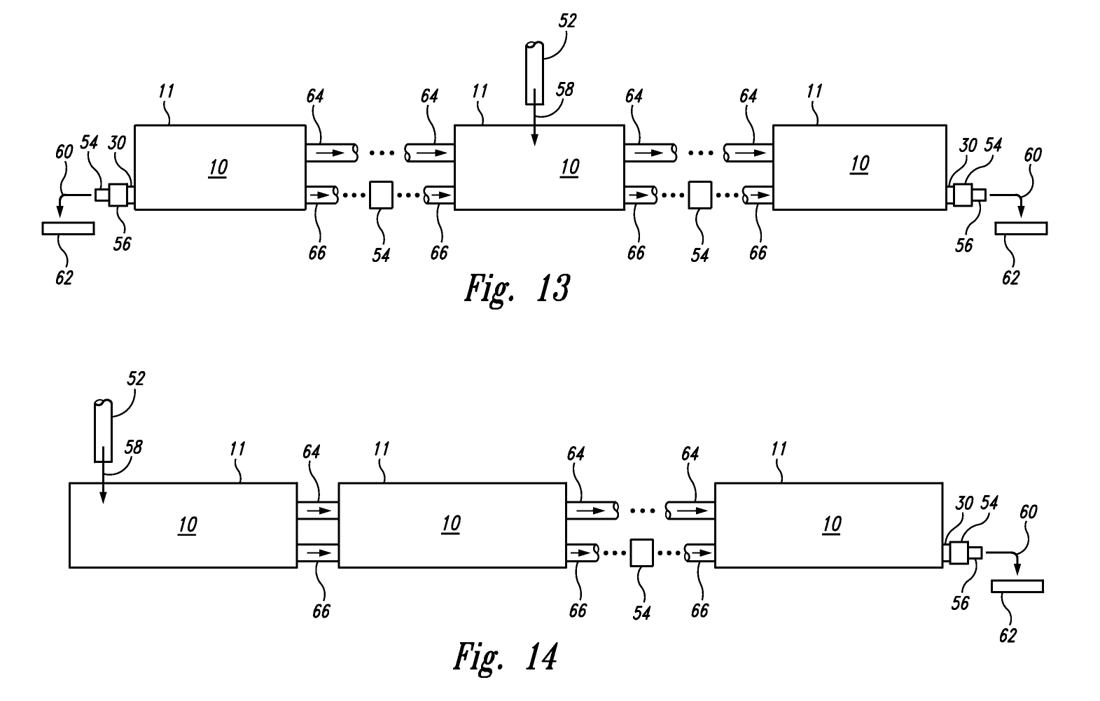

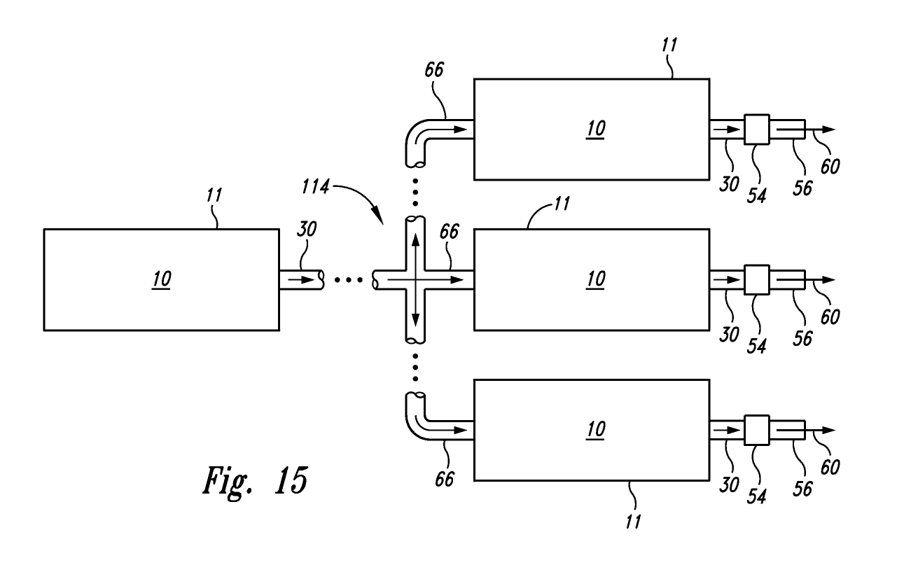

FIG. 13 is a side-elevational longitudinal view of an exemplary implementation showing multiple portable stormwater treatment systems 10 coupled together to form a network of portable stormwater treatment systems in which stormwater is being introduced at a mid-point system of the network. FIG. 14 is a side-elevational longitudinal view of an exemplary implementation showing multiple portable stormwater treatment systems 10 coupled together to form a network of portable stormwater treatment systems in which stormwater is introduced at an end-point system of the network. FIG. 15 is a top plan view of an exemplary implementation showing multiple portable stormwater treatment systems 10 coupled together in parallel along with others coupled in series to form a network of portable stormwater treatment systems.

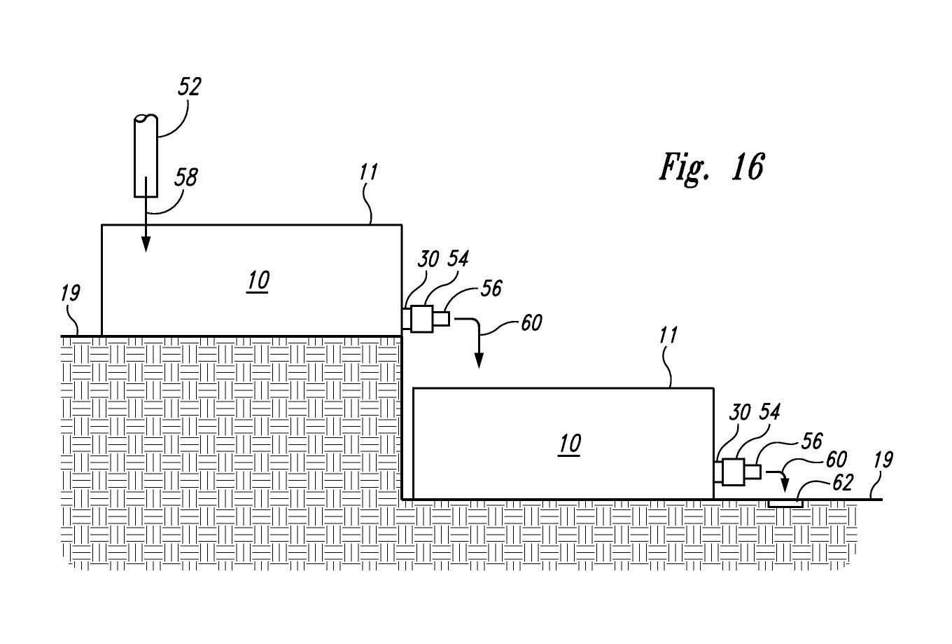

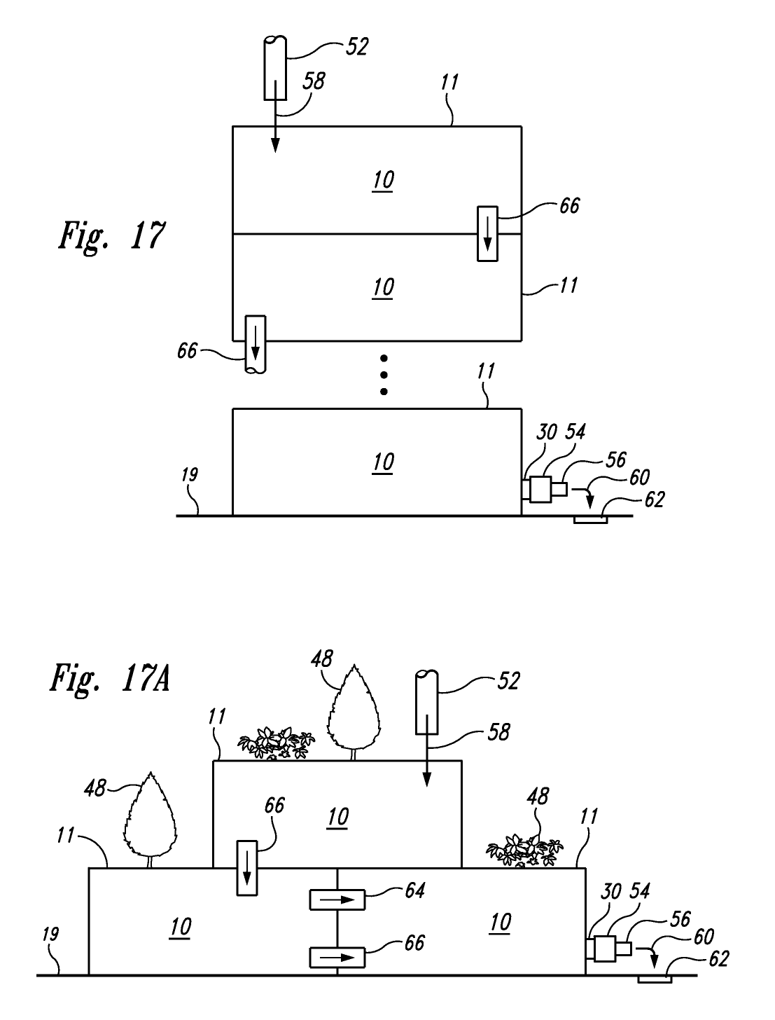

FIG. 16 is a side elevational view showing two portable stormwater treatment systems 10 having different elevations and forming a network of portable stormwater treatment systems. FIG. 17 is a side elevational view showing multiple portable stormwater treatment systems 10 vertically stacked to form a network of portable stormwater treatment systems. FIG. 17A is a side elevational view showing multiple portable stormwater treatment systems 10 vertically stacked in a staggered fashion thereby allowing for plant growth therein and thereby forming a network of portable stormwater treatment systems.

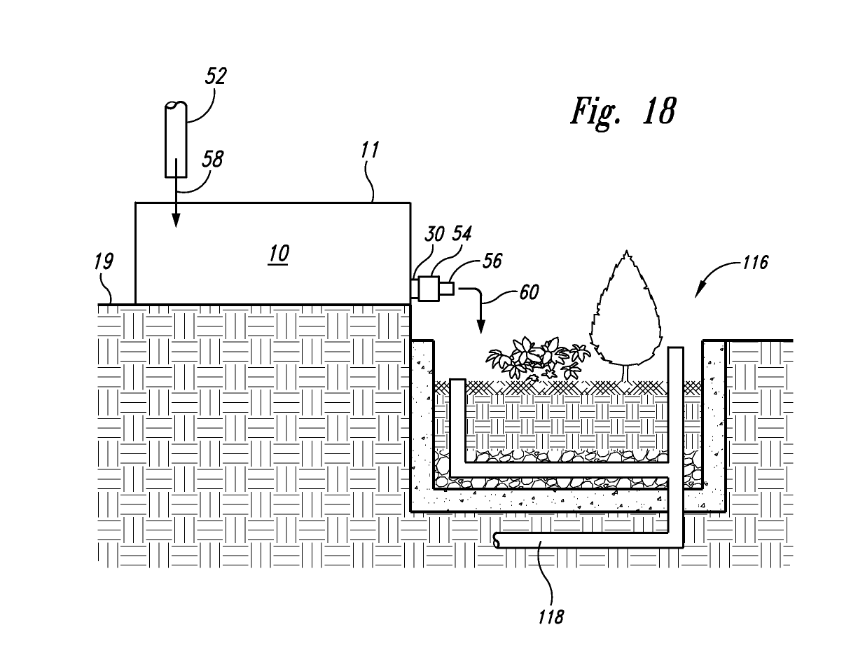

FIG. 18 is a side elevational view showing a portable stormwater treatment system 10 integrated with a conventional inground stormwater treatment system having different elevations.

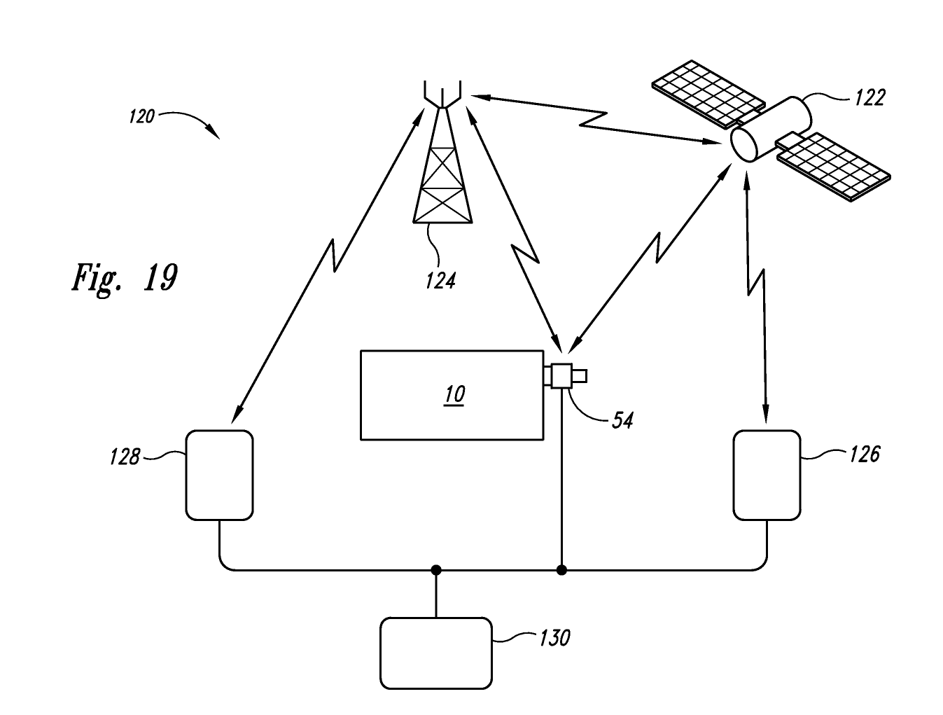

FIG. 19 is a schematic view of a remotely controlled portable stormwater treatment system 10 via a communication network 120 including satellite 122, wireless communication tower 124, satellite transceiver 126, wireless communication transceiver 128, and network server 130. Other implementations of communication networks could include cellular, wifi, 3G, 4G, frequency division multiplexing, time division multiplexing, or other communication modalities to remotely control the valve assembly 56.

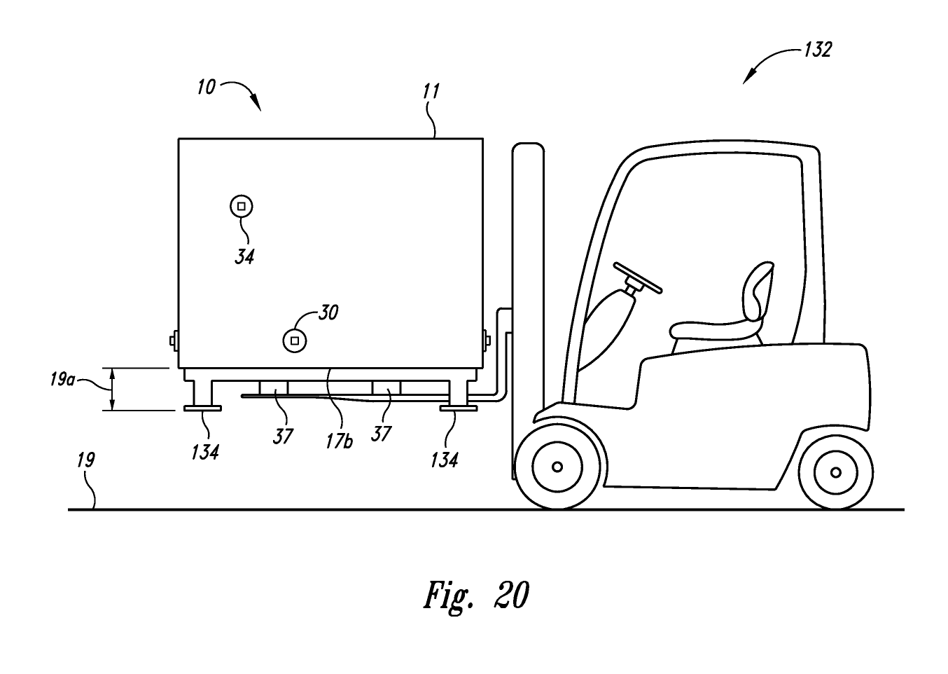

FIG. 20 is a side elevational view of a forklift 132 lifting an exemplary implementation of a portable stormwater treatment system 10 having members 18 as stands 134. Depending upon longitudinal dimension of the portable stormwater treatment system 10, contact surface area of forklift forks can be less than 20% or less than 10% of the total surface area of the exterior surface portions of the floor portions 16. This further suggests that structural reinforcement of the floor portions would be in order as discussed above especially if the portable stormwater treatment system 10 were to be moved by forklift when full of treatment materials.

Use of Trademarks in Specification Language:

This application may make reference to one or more trademarks, e.g., a word, letter, symbol, or device adopted by one manufacturer or merchant and used to identify and/or distinguish his or her product from those of others. Trademark names used herein are set forth in such language that makes clear their identity, that distinguishes them from common descriptive nouns, that have fixed and definite meanings, or, in many if not all cases, are accompanied by other specific identification using terms not covered by trademark. In addition, trademark names used herein have meanings that are well-known and defined in the literature, or do not refer to products or compounds for which knowledge of one or more trade secrets is required in order to divine their meaning. All trademarks referenced in this application are the property of their respective owners, and the appearance of one or more trademarks in this application does not diminish or otherwise adversely affect the validity of the one or more trademarks. All trademarks, registered or unregistered, that appear in this application are assumed to include a proper trademark symbol, e.g., the circle R or bracketed capitalization (e.g., [trademark name]), even when such trademark symbol does not explicitly appear next to the trademark. To the extent a trademark is used in a descriptive manner to refer to a product or process, that trademark should be interpreted to represent the corresponding product or process as of the date of the filing of this patent application.

Caselaw-Driven Clarification Language:

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

What is claimed is:

1. A portable stormwater treatment system comprising:
a freestandable container including one or more floor portions with one or more interior surface portions, with one or more exterior surface portions, and with a perimeter, said freestandable container including one or more wall portions coupled to said one or more floor portions and extending at least in part from said perimeter of said one or more floor portions to bound an interior space by said one or more interior surface portions of said one or more floor portions and said one or more wall portions;
one or more piping portions including one or more perforated piping portions having a plurality of perforations for receiving water, said one or more perforated piping portions extending through said interior space and coupled to one or more passageways through one or more of said wall portions; and
a plurality of members coupled to said one or more floor portions and extending from said one or more floor portions to distance said one or more exterior surface portions of said one or more floor portions from a horizontally oriented surface when said plurality of members are in contact therewith.

2. The portable stormwater treatment system of claim 1, wherein a freestandable container including one or more floor portions with one or more interior surface portions, with one or more exterior surface portions, and with a perimeter, said freestandable container including one or more wall portions coupled to said one or more floor portions and extending at least in part from said perimeter of said one or more floor portions to bound an interior space by said one or more interior surface portions of said one or more floor portions and said one or more wall portions comprises:
a freestandable container including the one or more floor portions with one or more interior surface portions, with one or more exterior surface portions, and with a perimeter, said freestandable container including one or more wall portions coupled to said one or more floor portions and extending at least in part from said perimeter of said one or more floor portions to bound an interior space by said one or more interior surface portions of said one or more floor portions and said one or more wall portions with the one or more floor portions including structural reinforcement of the one or more floor portions to provide load bearing capacity by the one or more floor portions of at least 150 pounds per square foot of a load upon said one or more interior surface portions of one or more floor portions.

3. The portable stormwater treatment system of claim 1, wherein a freestandable container including one or more floor portions with one or more interior surface portions, with one or more exterior surface portions, and with a perimeter, said freestandable container including one or more wall portions coupled to said one or more floor portions and extending at least in part from said perimeter of said one or more floor portions to bound an interior space by said one or more interior surface portions of said one or more floor portions and said one or more wall portions comprises:
a freestandable container including the one or more floor portions with one or more interior surface portions, with one or more exterior surface portions, and with a perimeter, said freestandable container including one or more wall portions coupled to said one or more floor portions and extending at least in part from said perimeter of said one or more floor portions to bound an interior space by said one or more interior surface portions of said one or more floor portions and said one or more wall portions with the one or more floor portions including structural reinforcement of the one or more floor portions to provide load bearing capacity of the one or more floor portions of at least 150 pounds per square foot of a load upon said one or more interior surface portions of one or more floor portions and to contact said freestandable container with a horizontally oriented surface through said plurality of members sized and shaped with total surface area of said plurality of members to contact said horizontally oriented surface of less than five percent in amount of total surface area of said exterior surface portions of said one or more floor portions.

4. The portable stormwater treatment system of claim 1, wherein a freestandable container including one or more floor portions with one or more interior surface portions, with one or more exterior surface portions, and with a perimeter, said freestandable container including one or more wall portions coupled to said one or more floor portions and extending at least in part from said perimeter of said one or more floor portions to bound an interior space by said one or more interior surface portions of said one or more floor portions and said one or more wall portions comprises:
the freestandable container including the one or more floor portions with one or more interior surface portions, with one or more exterior surface portions, and with a perimeter, said freestandable container including one or more wall portions coupled to said one or more floor portions and extending at least in part from said perimeter of said one or more floor portions to bound an interior space by said one or more interior surface portions of said one or more floor portions and said one or more wall portions, the freestandable container including structural reinforcement to provide load bearing capacity by the one or more floor portions of at least 150 pounds per square foot of a load upon said one or more interior surface portions of one or more floor portions and to accommodate lifting of the freestandable container through forklift forks contacting less than 20% of total surface area of said one or more exterior surface portions of said one or more floor portions while said freestandable container contains said load.

5. The portable stormwater treatment system of claim 1, wherein a freestandable container including one or more floor portions with one or more interior surface portions, with one or more exterior surface portions, and with a perimeter, said freestandable container including one or more wall portions coupled to said one or more floor portions and extending at least in part from said perimeter of said one or more floor portions to bound an interior space by said one or more interior surface portions of said one or more floor portions and said one or more wall portions comprises:
the freestandable container including the one or more floor portions with one or more interior surface portions, with one or more exterior surface portions, and with a perimeter, said freestandable container including one or more wall portions coupled to said one or more floor portions and extending at least in part from said perimeter of said one or more floor portions to bound an interior space by said one or more interior surface portions of said one or more floor portions and said one or more wall portions, the freestandable container including structural reinforcement to provide load bearing capacity by the one or more floor portions of at least 150 pounds per square foot of a load upon said one or more interior surface portions of one or more floor portions and to accommodate lifting of the freestandable container through forklift forks contacting less than 10% of total surface area of said one or more exterior surface portions of said one or more floor portions while said freestandable container contains said load.

6. The portable stormwater treatment system of claim 1, wherein a freestandable container including one or more floor portions with one or more interior surface portions, with one or more exterior surface portions, and with a perimeter, said freestandable container including one or more wall portions coupled to said one or more floor portions and extending at least in part from said perimeter of said one or more floor portions to bound an interior space by said one or more interior surface portions of said one or more floor portions and said one or more wall portions comprises:
the freestandable container including the one or more floor portions with one or more interior surface portions, with one or more exterior surface portions, and with a perimeter, said freestandable container including one or more wall portions coupled to said one or more floor portions and extending at least in part from said perimeter of said one or more floor portions to bound an interior space by said one or more interior surface portions of said one or more floor portions and said one or more wall portions, the freestandable container including a plurality of points of attachment for coupling of one or more hook portions and including structural reinforcement to provide load bearing capacity by the one or more floor portions of at least 150 pounds per square foot of a load upon said one or more interior surface portions of one or more floor portions and to accommodate lifting of the freestandable container through said one or more hook portions while coupled to said plurality of points of attachment and while said freestandable container contains said load.

7. The portable stormwater treatment system of claim 1, wherein a freestandable container including one or more floor portions with one or more interior surface portions, with one or more exterior surface portions, and with a perimeter, said freestandable container including one or more wall portions coupled to said one or more floor portions and extending at least in part from said perimeter of said one or more floor portions to bound an interior space by said one or more interior surface portions of said one or more floor portions and said one or more wall portions comprises:
a freestandable container including the one or more floor portions with one or more interior surface portions, with one or more exterior surface portions, and with a perimeter, said freestandable container including one or more wall portions coupled to said one or more floor portions and extending at least in part from said perimeter of said one or more floor portions to bound an interior space by said one or more interior surface portions of said one or more floor portions and said one or more wall portions with the one or more floor portions including structural reinforcement for said freestandable container to contact a horizontally oriented surface through said plurality of members sized and shaped with total surface area of said plurality of members to contact said horizontally oriented surface of less than five percent in amount of total surface area of said exterior surface portions of said one or more floor portions.

8. The portable stormwater treatment system of claim 1, wherein a freestandable container including one or more floor portions with one or more interior surface portions, with one or more exterior surface portions, and with a perimeter, said freestandable container including one or more wall portions coupled to said one or more floor portions and extending at least in part from said perimeter of said one or more floor portions to bound an interior space by said one or more interior surface portions of said one or more floor portions and said one or more wall portions comprises:
the freestandable container including the one or more floor portions with one or more interior surface portions, with one or more exterior surface portions, and with a perimeter, said freestandable container including one or more wall portions coupled to said one or more floor portions and extending at least in part from said perimeter of said one or more floor portions to bound an interior space by said one or more interior surface portions of said one or more floor portions and said one or more wall portions, the freestandable container including structural reinforcement to provide load bearing capacity to accommodate lifting of the freestandable container by forklift forks contacting less than 20% of total surface area of said one or more exterior surface portions of said one or more floor portions.

9. The portable stormwater treatment system of claim 1, wherein a freestandable container including one or more floor portions with one or more interior surface portions, with one or more exterior surface portions, and with a perimeter, said freestandable container including one or more wall portions coupled to said one or more floor portions and extending at least in part from said perimeter of said one or more floor portions to bound an interior space by said one or more interior surface portions of said one or more floor portions and said one or more wall portions comprises:
the freestandable container including the one or more floor portions with one or more interior surface portions, with one or more exterior surface portions, and with a perimeter, said freestandable container including one or more wall portions coupled to said one or more floor portions and extending at least in part from said perimeter of said one or more floor portions to bound an interior space by said one or more interior surface portions of said one or more floor portions and said one or more wall portions, the freestandable container including structural reinforcement to provide load bearing capacity to accommodate lifting of the freestandable container by forklift forks contacting less than 10% of total surface area of said one or more exterior surface portions of said one or more floor portions.

10. The portable stormwater treatment system of claim 1, wherein a freestandable container including one or more floor portions with one or more interior surface portions, with one or more exterior surface portions, and with a perimeter, said freestandable container including one or more wall portions coupled to said one or more floor portions and extending at least in part from said perimeter of said one or more floor portions to bound an interior space by said one or more interior surface portions of said one or more floor portions and said one or more wall portions comprises:
the freestandable container including the one or more floor portions with one or more interior surface portions, with one or more exterior surface portions, and with a perimeter, said freestandable container including one or more wall portions coupled to said one or more floor portions and extending at least in part from said perimeter of said one or more floor portions to bound an interior space by said one or more interior surface portions of said one or more floor portions and said one or more wall portions, the freestandable container including a plurality of points of attachment for coupling of one or more hook portions and including structural reinforcement to provide load bearing capacity to accommodate lifting of the freestandable container through said one or more hook portions coupled to said plurality of points of attachment.

11. The portable stormwater treatment system of claim 1, wherein one or more piping portions including one or more perforated piping portions having a plurality of perforations for receiving water, said one or more perforated piping portions extending through said interior space and coupled to one or more passageways through one or more of said wall portions comprises:
the one or more piping portions including one or more perforated piping portions having a plurality of perforations for receiving water, said one or more perforated piping portions extending through said interior space and coupled to one or more passageways through one or more of said wall portions, the one or more piping portions including one or more overflow piping portions positioned within the interior space and having a first end for receiving water, the first end of the one or more overflow piping portions spaced from the one or more floor portions farther than the one or more perforated piping portions are spaced from the one or more floor portions.

12. The portable stormwater treatment system of claim 1, wherein a plurality of members coupled to said one or more floor portions and extending from said one or more exterior surfaces of said one or more floor portions to distance said one or more exterior surface portions of said one or more floor portions from a horizontally oriented surface when said plurality of members are in contact therewith comprises:
the plurality of members coupled to said one or more floor portions and extending from said one or more exterior surfaces of said one or more floor portions to distance said one or more exterior surface portions of said one or more floor portions from a horizontally oriented surface when said plurality of members are in contact therewith, at least some of the plurality of members having wheel portions coupled to said one or more floor portions, the one or more wheel portions sized and positioned for support of the freestandable container at least upon a horizontally oriented surface of sufficient firmness to bear the free standing container without deformation of the horizontally oriented surface and to allow for movement of the freestandable container along at least a first direction when the wheel portions are supporting the free standing container upon the horizontally oriented surface and are rotating.

13. The portable stormwater treatment system of claim 1, wherein a plurality of members coupled to said one or more floor portions and extending from said one or more exterior surfaces of said one or more floor portions to distance said one or more exterior surface portions of said one or more floor portions from a horizontally oriented surface when said plurality of members are in contact therewith comprises:
the plurality of members coupled to said one or more floor portions and extending from said one or more exterior surfaces of said one or more floor portions to distance said one or more exterior surface portions of said one or more floor portions from a horizontally oriented surface when said plurality of members are in contact therewith, at least some of the plurality of members having wheel portions coupled to said one or more floor portions, the one or more wheel portions sized and positioned for support of the freestandable container at least upon a horizontally oriented surface of sufficient firmness to bear the free standing container without deformation of the horizontally oriented surface with the one or more floor portions bearing a load of at least 150 pounds per square foot and to allow for movement of the freestandable container along at least a first direction when the wheel portions are supporting the free standing container upon the horizontally oriented surface and are rotating while the free standing container contains the load.

14. The portable stormwater treatment system of claim 1, wherein a plurality of members coupled to said one or more floor portions and extending from said one or more exterior surfaces of said one or more floor portions to distance said one or more exterior surface portions of said one or more floor portions from a horizontally oriented surface when said plurality of members are in contact therewith comprises:
the plurality of members coupled to said one or more floor portions and extending from said one or more exterior surfaces of said one or more floor portions to distance said one or more exterior surface portions of said one or more floor portions from a horizontally oriented surface when said plurality of members are in contact therewith, at least some of the plurality of members coupled to said one or more floor portions through one or more frictional forces, one or more bolted portions, or one or more welded portions.

15. The portable stormwater treatment system of claim 1, wherein a plurality of members coupled to said one or more floor portions and extending from said one or more exterior surfaces of said one or more floor portions to distance said one or more exterior surface portions of said one or more floor portions from a horizontally oriented surface when said plurality of members are in contact therewith comprises:
the plurality of members coupled to said one or more floor portions and extending from said one or more exterior surfaces of said one or more floor portions to distance said one or more exterior surface portions of said one or more floor portions from a horizontally oriented surface when said plurality of members are in contact therewith, at least some of the plurality of members being positioned in a plurality of corner areas of said one or more floor portions.

16. A portable stormwater treatment system comprising:
a freestandable container including one or more floor portions and including one or more wall portions extending therefrom to define an interior space thereby;
one or more piping portions including one or more perforated piping portions having a plurality of perforations for receiving water, said one or more perforated piping portions extending through said interior space and coupled to one or more passageways through one or more of said wall portions; and
one or more points of attachment coupled to said freestandable container for coupling of one or more hook portions and including structural reinforcement of said one or more points of attachment and including structural reinforcement of said freestandable container to provide load bearing capacity to accommodate lifting of said freestandable container through said one or more hook portions coupled to said one or more points of attachment.

17. The portable stormwater treatment system of claim 1, wherein one or more points of attachment coupled to said freestandable container for coupling of one or more hook portions and including structural reinforcement of said one or more points of attachment and including structural reinforcement of said freestandable container to provide load bearing capacity to accommodate lifting of said freestandable container through said one or more hook portions coupled to said one or more points of attachment comprises:
one or more points of attachment coupled to said freestandable container for coupling of one or more hook portions and including structural reinforcement of said one or more points of attachment and including structural reinforcement of said freestandable container to provide load bearing capacity to accommodate lifting of said freestandable container through said one or more hook portions coupled to said one or more points of attachment, the one or more points of attachment and the freestandable container including structural reinforcement to provide load bearing capacity by the one or more floor portions of at least 150 pounds per square foot of a load upon said one or more interior surface portions of one or more floor portions and to accommodate lifting of the freestandable container through said one or more hook portions while coupled to said one or more points of attachment and while said freestandable container contains said load.

18. A portable stormwater treatment system comprising:
a freestandable container including one or more floor portions and including one or more wall portions coupled to said one or more floor portions and extending therefrom to bound an interior space by said one or more floor portions and said one or more wall portions, said freestandable container including structural strengthening to provide rigidity for at least partial lifting of said freestandable container;
one or more piping portions coupled therewith, said one or more piping portions at least including one or more perforated piping portions having a plurality of perforations for receiving water, said one or more perforated piping portions extending through said interior space and coupled to one or more passageways through one or more of said wall portions; and
a valve assembly coupled to said one or more piping portions, the valve assembly having at least two cross-sectional area settings for adjustment of flow rate of fluid through said valve assembly.

19. A portable stormwater treatment system comprising:
a first freestandable container including one or more floor portions and including one or more wall portions coupled to said one or more floor portions and extending therefrom to bound an interior space by said one or more floor portions and said one or more wall portions, said first freestandable container including structural reinforcement to provide rigidity for at least partial lifting of a portion of said first freestandable container from prior ground contact;
a first piping system including one or more perforated piping portions coupled therewith, the one or more perforated piping portions having a plurality of perforations for receiving water, said one or more perforated piping portions extending through said interior space of said first freestandable container and coupled to one or more passageways through one or more of said wall portions of said first freestandable container;
a second freestandable container for placement including at least aboveground placement, said second freestandable container including one or more floor portions and including one or more wall portions coupled to said one or more floor portions and extending therefrom to bound an interior space by said one or more floor portions and said one or more wall portions, said second freestandable container including structural reinforcement to provide rigidity for at least partial lifting of a portion of said second freestandable container from prior ground contact; and
a second piping system including one or more perforated piping portions coupled therewith, the one or more perforated piping portions having a plurality of perforations for receiving water, said one or more perforated piping portions extending through said interior space of said second freestandable container and coupled to one or more passageways through one or more of said wall portions of said second freestandable container, said first piping system of said first freestandable container being coupled to said second piping system of said second freestandable container.

20. A method of providing stormwater treatment comprising:
providing a first freestandable container including one or more floor portions and including one or more wall portions coupled to said one or more floor portions and extending therefrom to bound an interior space by said one or more floor portions and said one or more wall portions, said first freestandable container including structural reinforcement to provide rigidity for at least partial lifting of a portion of said first freestandable container from prior ground contact;
providing a first piping system including one or more perforated piping portions coupled therewith, the one or more perforated piping portions having a plurality of perforations for receiving water, said one or more perforated piping portions extending through said interior space of said first freestandable container and coupled to one or more passageways through one or more of said wall portions of said first freestandable container;
providing a second freestandable container for placement including at least aboveground placement, said second freestandable container including one or more floor portions and including one or more wall portions coupled to said one or more floor portions and extending therefrom to bound an interior space by said one or more floor portions and said one or more wall portions, said second freestandable container including structural reinforcement to provide rigidity for at least partial lifting of a portion of said second freestandable container from prior ground contact;
providing a second piping system including one or more perforated piping portions coupled therewith, the one or more perforated piping portions having a plurality of perforations for receiving water, said one or more perforated piping portions extending through said interior space of said second freestandable container and coupled to one or more passageways through one or more of said wall portions of said second freestandable container; and
coupling said first piping system of the first freestandable container to said second piping system of said second freestandable container.
